(19) United States
(12) Patent Application Publication
(10) Pub. No.: US 2018/0210630 A1
(43) Pub. Date: Jul. 26, 2018

(54) DISPLAY DEVICE AND DISPLAY METHOD

(71) Applicant: KYOCERA Document Solutions Inc., Osaka (JP)

(72) Inventors: Yoichi Hiranuma, Osaka (JP); Hiroki Takehana, Osaka (JP); Etsuko Manda, Osaka (JP)

(21) Appl. No.: 15/879,461

(22) Filed: Jan. 25, 2018

(30) Foreign Application Priority Data
Jan. 26, 2017 (JP) 2017-012417
Jan. 26, 2017 (JP) 2017-012419

(51) Int. Cl. G06F 3/0481; G06F 3/0482; G06F 3/041

(52) U.S. Cl. CPC G06F 3/04817; G06F 3/0416; G06F 3/0482

(57) ABSTRACT

A display device includes a first reception unit, a determination unit, and a display control unit. The first reception unit receives a request for display of a plurality of lists. The determination unit determines, when the first reception unit receives the request for display, whether or not it is possible to display all of items in a display area of a display screen in an arrangement direction of the items for each of the lists. The display control unit performs, in sequentially displaying the plurality of lists in the display area, control such that, for the list for which the determination unit has determined that it is not possible to display all of the items, all of the items in the list are displayed once, and then, only some of the items are displayed.

### CROSS REFERENCE TO RELATED APPLICATIONS

This application claims priority to Japanese Patent Application No. 2017-012417, which was filed on Jan. 26, 2017, and Japanese Patent Application No. 2017-012419, which was filed on Jan. 26, 2017, and is incorporated herein by reference in its entirety.

### BACKGROUND

The present disclosure relates to a display device and a display method.

A technology related to display of information has been conventionally known.

A typical window system is configured such that, in the window system in which one or more windows are opened on a screen and a text, a graphic, or the like is displayed in each of the windows, when a predetermined window is opened, display contents are automatically scrolled.

A typical information terminal device includes a display unit, a screen scrolling unit that scrolls a display of a screen of the display unit in a predetermined first direction, a display information acquisition unit that acquires information displayed on the screen, a display contents detection unit that determines whether or not contents exist in the information that is displayed on the screen, a non-display contents detection unit that determines whether or not the contents exist in a second direction that crosses the first direction when the existence of the contents is not confirmed on one screen in the first direction, and a display position determination unit that stops, when the existence of the contents has been confirmed, scrolling the display of the screen and determines a display position of the screen.

### SUMMARY

A display device according to the present disclosure is able to display a plurality of lists which are classified into a plurality of groups for each predetermined category and in which a plurality of items is arranged in a predetermined order. The display device includes a display screen, a first reception unit, a determination unit, and a display control unit. The display screen displays information. The first reception unit receives a request for display of the plurality of lists. The determination unit determines, when the first reception unit receives the request for display, whether or not it is possible to display all of items in a display area of the display screen in an arrangement direction of the items for each of the lists. The display control unit performs, in sequentially displaying the plurality of lists in the display area, control such that, for the list for which the determination unit has determined that it is not possible to display all of the items, all of the items in the list are displayed once, and then, only some of the items are displayed.

### BRIEF DESCRIPTION OF THE DRAWINGS

FIG. 1 is a view illustrating an outside appearance of a mobile terminal device that is an example of a display device according to an embodiment.

FIG. 2 is a block diagram illustrating a configuration of the mobile terminal device illustrated in FIG. 1.

FIG. 3 is a diagram illustrating an example of a list displayed on a display area of a display screen.

FIG. 4 is a flowchart illustrating a flow of processing when a plurality of lists is displayed using a mobile terminal device including a display device.

FIG. 5 is a conceptual diagram when a length of a list of last names of an “A” column of the Japanese syllabary is calculated.

FIG. 6 is a diagram illustrating the display screen when a list of last names of the “A” column of the Japanese syllabary is displayed.

FIG. 7 is a diagram illustrating the display screen when items are displayed.

FIG. 8 is a diagram illustrating the display screen when a list of last names of a “KA” column of the Japanese syllabary is displayed.

FIG. 9 is a diagram illustrating an example of the display screen when there is not any relevant item.

FIG. 10 is a flowchart illustrating a flow of processing when a plurality of lists is reduced in size and is simultaneously arranged and displayed.

FIG. 11 is a diagram illustrating a part of an example of the display screen in which each list is reduced in size and the lists are simultaneously arranged and displayed.

FIG. 12 is a block diagram illustrating a configuration of a multifunction peripheral when an information processing device including a display device according to another embodiment is applied to the multifunction peripheral.

FIG. 13 is a flowchart illustrating a flow of processing when icons of functions which are classified into a plurality of groups.

FIG. 14 is a diagram illustrating an example of the display screen in which a plurality of icons is arranged and displayed.

FIG. 15 is a diagram illustrating an example of the display screen that is displayed when selection of an icon is received.

FIG. 16 is a diagram illustrating an example of the display screen when a detailed setting of a function which is farthest from a center is displayed.

### DETAILED DESCRIPTION

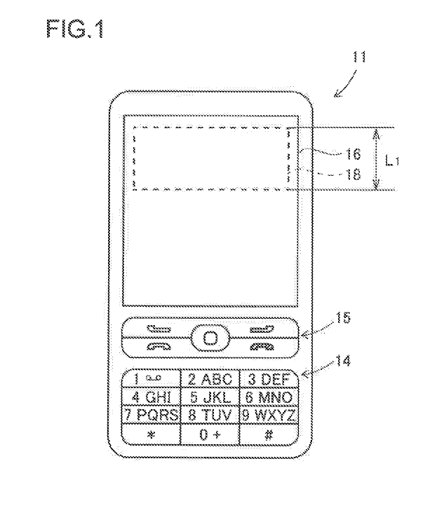

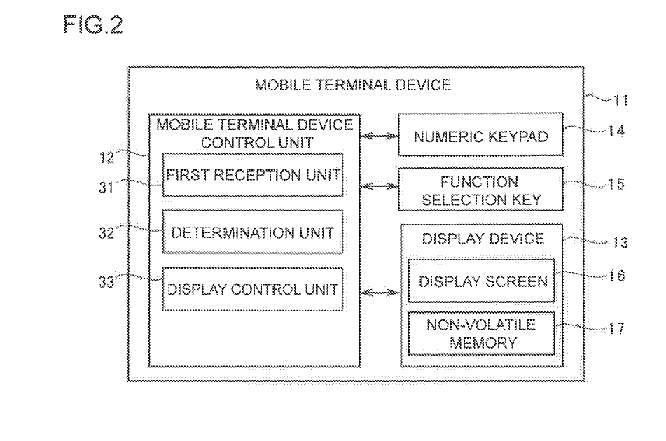

Embodiments will be described below. FIG. 1 is a view illustrating an outside appearance of a mobile terminal device that is an example of a display device according to an embodiment. FIG. 2 is a block diagram illustrating a configuration of the mobile terminal device illustrated in FIG. 1.

With reference to FIG. 1 and FIG. 2, a mobile terminal device 11 includes a mobile terminal device control unit 12, a display device 13, a numeric keypad 14, and a function selection key 15. Note that the mobile terminal device 11 is, for example, configured to be communicable with an external electronic device.

The mobile terminal device control unit 12 includes a processor, a random access memory (RAM), a read only memory (ROM), or the like. The processor is a central processing unit (CPU), ASIC, MCU, or the like. A control program stored in ROM described above or a storage unit (not illustrated) is executed by the processor described above, and thereby, the mobile terminal device control unit 12 functions as a first reception unit 31, a determination unit 32, and a display control unit 33, which will be described later, and controls the mobile terminal device 11 itself including the display device 13. Note that each of the component elements described above of the mobile terminal device control unit 12 may be formed of a hard circuit, not depending on an operation based on the control program described above. A user is able to input a numeric value of 0 to 9, an alphabet of A to Z, or the like by pressing down a key of the numeric keypad 14. Also, the user is able to perform various operations by pressing down a predetermined part of the function selection key 15. For example, the user selects a mobile phone function in the mobile terminal device 11 and starts or ends a voice call by pressing down the function selection key 15.

Next, a configuration of the display device 13 will be described. The display device 13 includes a display screen 16 and a non-volatile memory 17 as a storage unit. The display screen 16 displays information. The display screen 16 displays a list, which will be described later, in a display area 18 that is surrounded by a rectangle in broken lines in FIG. 1. The non-volatile memory 17 stores various types of data. Specifically, for example, the non-volatile memory 17 stores information of a plurality of lists which are classified into a plurality of groups for each predetermined category and in which a plurality of items is arranged in a predetermined order. The display screen 16 serves as an interface of an output to the user when information is displayed in the mobile terminal device 11. That is, in the display screen 16, various types of information in the mobile terminal device 11 are displayed, and also, input contents by the user or the like are displayed. The display screen 16 is a touch panel type and also serves as an interface of an input from the user to the mobile terminal device 11. That is, the user looks at contents displayed on the display screen 16 and performs an operation, such as an input of an order of execution to the mobile terminal device 11 or the like, by tapping an icon using a finger.

The display device 13 is able to display the plurality of lists which are classified into a plurality of groups for each predetermined category and in which items is arranged in a predetermined order. Examples of the predetermined category include, for example, a person's name category, such as a so-called an address book, in which individual information is stored in the non-volatile memory 17, which will be described. The plurality of groups into which the lists are classified are groups of names, such as names of an “A” column of the Japanese syllabary, names of a “KA” column of the Japanese syllabary, or the like, into which lists are classified for each of columns in an order of the Japanese syllabary. Items are, for example, persons' names, that is, specifically, last names, such as “AOKI”, “KATO”, or the like.

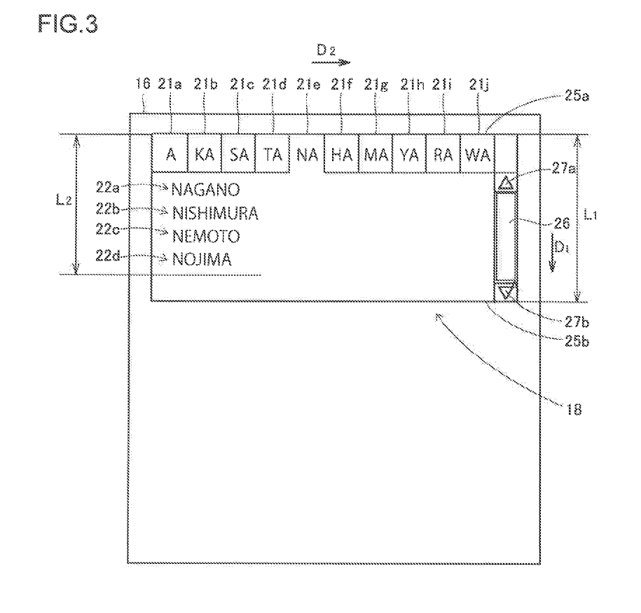

FIG. 3 is a diagram illustrating an example of a list displayed on the display area 18 of the display screen 16. With reference to FIG. 3, in the display area 18 of the display screen 16, a list 21e which is a part of an address book including a plurality of lists 21a, 21b, 21c, 21d, 21e, 21f, 21g, 21h, 21i, and 21j is displayed. The list 21e is rectangular and has a so-called laterally long shape. The lists 21a to 21j are displayed in a tab format so as to be arranged in a direction indicated by an arrow D₂. Each of the lists 21a to 21j is provided for each group, that is, each of groups into which the lists are classified for each category, such as each of the columns in the order of the Japanese syllabary, in this case. For example, for last names of the “A” column, the list 21a is provided, and for last names of the “KA” column, the list 21b is provided. In the example of FIG. 3, an item 22a of “NAGANO”, an item 22b of “NISHIMURA”, an item 22c of “NEMOTO”, and an item 22d of “NORMA” which form a group which belongs to last names of a “NA” column of the Japanese syllabary are displayed in the list 21e.

The items 22a to 22d are arranged and displayed from a top in a direction indicated by an arrow D₁ in a Japanese syllabary order “A, I, U, E, O . . . ”. The number of the items 22a to 22d which belong to the group of last names of the “NA” column indicated by the list 21e in total is four. That is, the number of the items 22a to 22d which are stored in the non-volatile memory 17 and belong to the group of last names of the “NA” column is four. A length of the list 21e in an arrangement direction, that is, specifically, a length of the list 21e from an upper end part 25a to a lower end part 25b in the arrangement direction indicated by the arrow D₁ in FIG. 3, is a length of the display area 18 in a longitudinal direction, which is illustrated in FIG. 1, and is denoted by a length L₁. The length L₁ is a length which is enough to allow, if the five items of the items 22a to 22d are arranged in the longitudinal direction that is the arrangement direction, all five of the items 22a to 22d to be displayed on the display area 18. Note that the direction indicated by the arrow D₁ and the direction indicated by the arrow D₂ meet at right angles.

In a right end of the list 21e, a rectangular bar 26 is displayed. In an upper side of the bar 26, an icon 27a that moves the bar 26 upward by tapping and shifts a display of the items 22a to 22d upward is displayed. In a lower side of the bar 26, an icon 27b that moves the bar 26 downward by tapping and shifts the display of the items 22a to 22d downward is displayed. The length in the arrangement direction of the items 22a to 22d is denoted by a length L₂. In this case, the length L₁ is longer than the length L₂, and therefore, for the group classified by the last names of the “NA” column, a configuration in which it is possible to display all of the items 22a to 22d in the list 21e at once is employed. Also, because all of the items 22a to 22d are already displayed in the list 21e, even when the user taps the icon 27a or the icon 27b, the display is not shifted in an up-and-down direction. This is clearly understood by visually recognizing the bar 26 that extends from the icon 27a to the icon 27b. Note that, for items that form each of the lists 21a to 21j, when display of the lists 21a to 21j is moved at predetermined speed, the items are displayed in a so-called “A KA SA TA NA” order, that is, an order of the list 21a, the list 21b, and finally, the list 21j.

In this case, the mobile terminal device control unit 12 includes the first reception unit 31, the determination unit 32, and the display control unit 33. The first reception unit 31 receives a request for display of the lists 21a to 21j. When the first reception unit 31 receives the request for display, the determination unit 32 determines whether or not it is possible to display all of items in the display area 18 of the display screen 16 in an arrangement direction of items for each of the lists 21a to 21j. In sequentially displaying the plurality of lists 21a to 21j in the display area 18, the display control unit 33 performs control such that, for a list for which the determination unit 32 has determined that it is not possible to display all of items, all of the items in the list are displayed once, and then, only some of the items are displayed. These configurations will be described later.

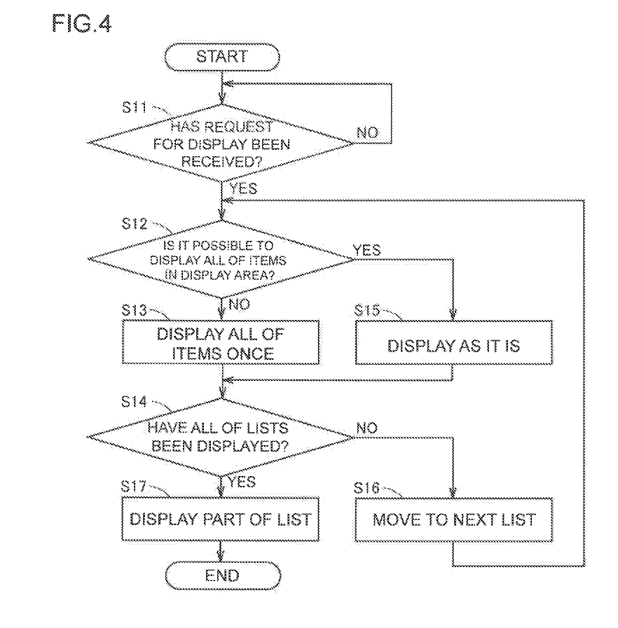

Next, a case in which the plurality of lists 21a to 21j is displayed using the mobile terminal device 11 including the display device 13 will be described. FIG. 4 is a flowchart illustrating a flow of processing when the plurality of lists 21a to 21j is displayed using the mobile terminal device 11 including the display device 13.

With reference FIG. 4, first, the first reception unit 31 determines whether or not the first reception unit 31 has received a request for display (in FIG. 4, Step S11, and “Step” will be hereinafter omitted). In this case, for example, in the display screen 16 of a touch panel type, whether or not the first reception unit 31 has received a request for display is determined based on whether or not a touch by a finger of the user, a tap onto an icon (not illustrated) which is displayed on the display screen 16 in connection with the address book described above, or the like has been detected.

When the first reception unit 31 receives the request for display (YES in S11), the determination unit 32 determines whether or not it is possible to display all of items in the display area 18 of the display screen 16 in the arrangement direction of the items for each of the lists 21a to 21j (S12). Specifically, the length L₂ in the arrangement direction indicated by the arrow D₁ when the items are arranged is calculated for each of the lists 21a to 21j. In this case, the length L₂ changes in accordance with the number of the items. Specifically, as the number of the items increases, the length L₂ increases. Then, it is determined whether or not the calculated length L₂ is longer than the length L₁.

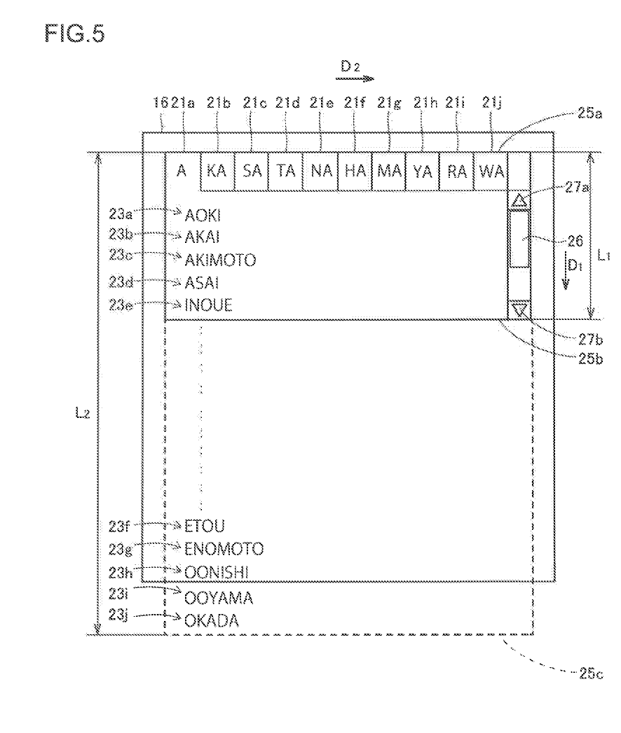

FIG. 5 is a conceptual diagram when the length L₂ of the list 21a of last names of the “A” column is calculated. With reference to FIG. 5, a group of last names of the “A” column is formed of an item 23a of “AOKI”, an item 23b of “AKAI”, an item 23c of “AKIMOTO”, an item 23d of “ASAI”, an item 23e of “INOUE”, (snip) an item 23f of “ETOU”, an item 23g of “ENOMOTO”, an item 23h of “OONISHI, an item 23i of “OOYAMA”, and an item 23j of “OKADA”. Then, the length in an arrangement direction in which the items 23a to 23j are arranged is denoted by the length L₂ from an upper end part 25a to a lower end part 25c indicated by a virtual broken line.

In this case, in sequentially displaying the plurality of lists 21a to 21j in the display area 18, the display control unit 33 performs control such that, for the list 21a for which the determination unit 32 has determined that it is not possible to display all of items, all of the items in the list 21a are displayed once, and then, only some of the items are displayed (S13). In this case, because the length L₂ is longer than the length L₁ in the list 21a, all of the items 23a to 23j in the list 21a are displayed once, and then, only some of the items 23a to 23j are displayed. In this case, the display control unit 33 performs control such that the items 23a to 23j are displayed by scrolling forward from the item 23j arranged last in the arrangement direction. Specifically, the display control unit 33 performs control such that display described below is performed.

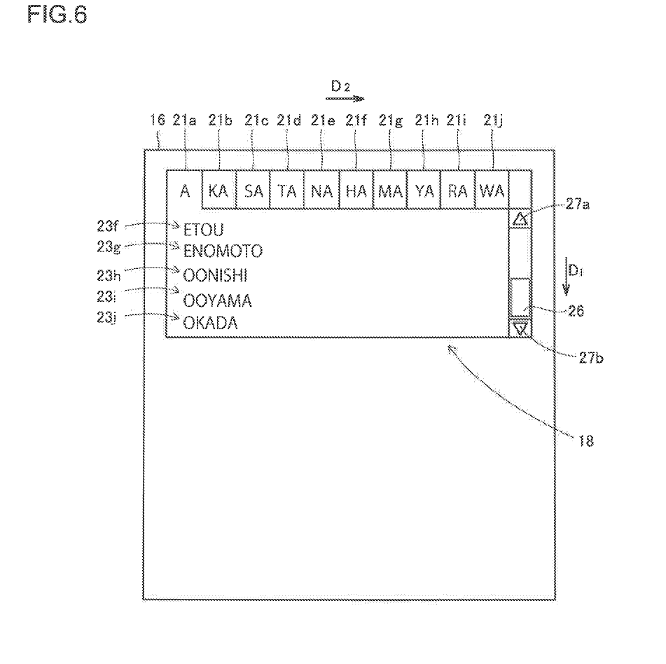

FIG. 6 is a diagram illustrating the display screen 16 when the list 21a of last names of the “A” column is displayed. With reference to FIG. 6, the display control unit 33 first displays the item 23j arranged last in the arrangement direction in the display area 18 of the display screen 16. In this case, the item 23f, the item 23g, the item 23h, and the item 23i that are arranged before the item 23j are displayed with the item 23j. Thereafter, the list 21a is scrolled forward, that is, in this case, in a direction opposite to the direction indicated by the arrow D₁. Thus, the item 23f and the item 23g that are arranged before the item 23h are displayed one after another in the display area 18 of the list 21a. Then, lastly, the item 23a arranged first is displayed.

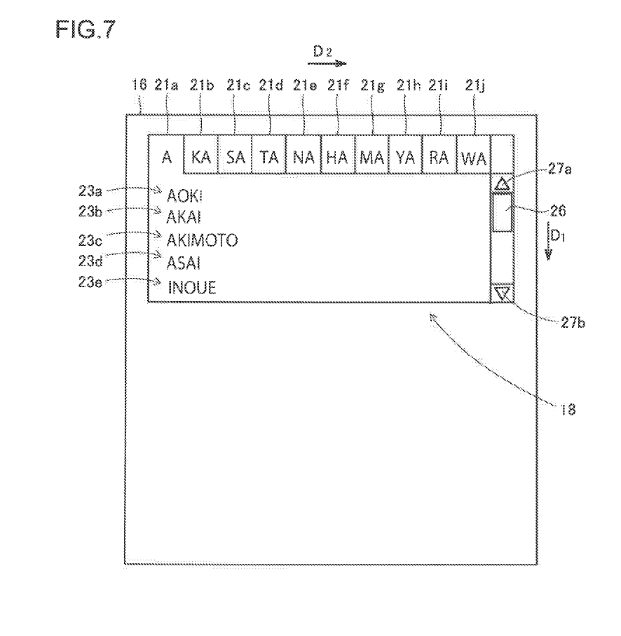

FIG. 7 is a diagram illustrating the display screen 16 when the item 23a is displayed. With reference to FIG. 7, the items 23a, 23b, 23c, 23d, and 23e are arranged and displayed in the longitudinal direction on the display screen 16. The item 23a is arranged first.

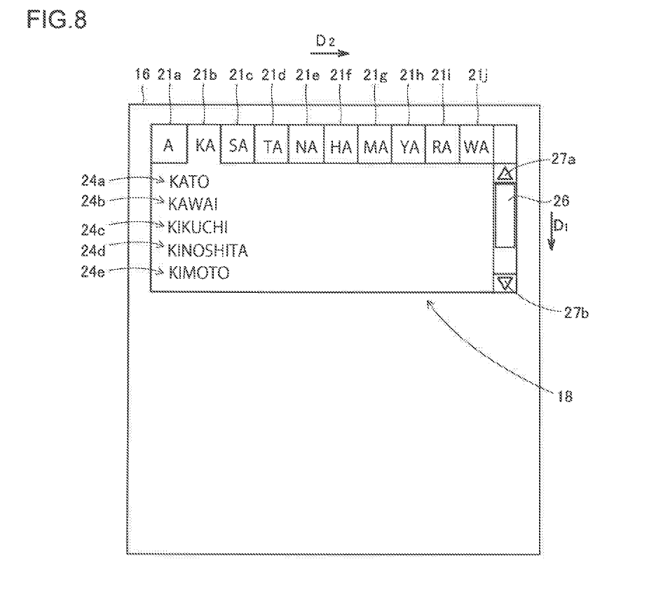

Thereafter, if there are the lists 21b to 21j which are to be displayed next (NO in S14), a target to be displayed is changed to the next list 21b and the list 21b is displayed (S16). Specifically, the next list 21b in the direction of the arrow D₂ is displayed. Also, in displaying the list 21b, whether or not the length L₂ is longer than the length L₁ is determined. Then, if it is determined that the length L₂ is longer than the length L₁, control is performed such that the items 24a, 24b, 24c, 24d, and 24e are displayed as illustrated in FIG. 8 by scrolling forward from an item arranged last in the arrangement direction in the same manner as the above-described manner. FIG. 8 is a diagram illustrating the display screen 16 when the list 21b of last names of the “KA” column is displayed. Note that, as in the list 21e illustrated in FIG. 3, if it is determined that the length L₂ is shorter than the L₁ (YES in S12), the list 21b is displayed as it is, that is, without scrolling, for a certain time (S15).

In the above-described manner, all of the lists 21a to 21j are displayed by the display control unit 33 (NO in S14, S16). Then, after display of all of the lists 21a to 21j is terminated once, a part of the list 21a is displayed again (YES in S14, S17).

In the mobile terminal device 11 including the display device 13, which has been described above, when the plurality of lists 21a to 21j are sequentially switched from one to another and displayed in the display area 18 of the display screen 16, for the list 21a for which it has been determined that it is not possible to display all of the items 23a to 23j, all of the items 23a to 23j in the list 21a are displayed once, and then, only some of the items 23a to 23j are displayed. Thus, it is easier to know all of the lists 21a to 21j that are classified for each predetermined category. In this case, a complicated operation is not performed by the user. Therefore, the convenience of the user may be increased.

In this case, in displaying the list 21a, the display control unit 33 performs control such that the items 23a to 23j are displayed by scrolling forward from the item 23j arranged last in the arrangement direction, and therefore, all of the items 23a to 23j that form the list 21a may be easily known.

Note that, in the above-described embodiment, display in a tab format is performed and, when such display in a tab format is performed, only a specific item or a predetermined setting item is displayed so that the above-described configuration is achieved.

Also, in the above-described embodiment, if there is not any relevant item in a list at all, it may be displayed in the list that there is not any relevant item in the list at all. That is, for example, if not any relevant item that belongs to a list 21i of last names of a “RA” column of the Japanese syllabary is stored in the non-volatile memory 17, it may be displayed that there is not any relevant item.

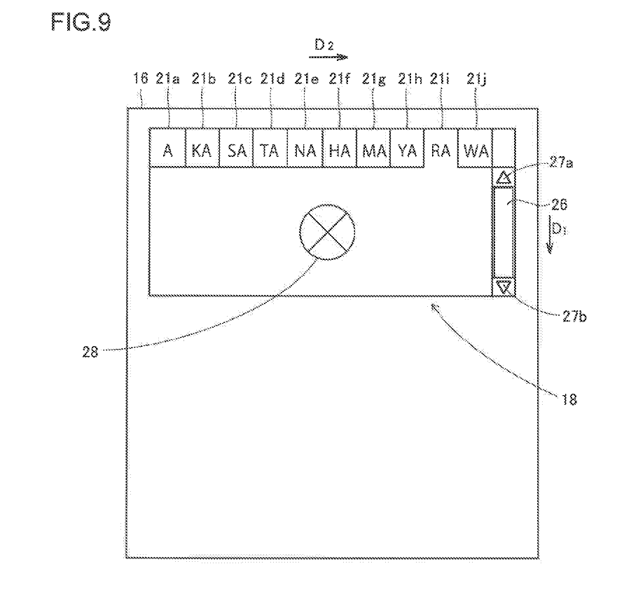

FIG. 9 is a diagram illustrating an example of the display screen 16 when there is not any relevant item. With reference to FIG. 9, if there is not any item of the “RA” column, which is to be indicated in the list 21i, at all, a mark 28 of a circle with x indicated therein, which indicates there is not any relevant item at all, is displayed. With this configuration, when the list 21i is displayed, the user is able to recognize that there is not any relevant item that belongs to the list 21i. Note that it may be another option to display by a simple text message or the like that there is not any relevant item at all.

Also, in the above-described embodiment, if there is not any relevant item that belong to a list at all, in sequentially displaying the plurality of lists 21a to 21j, display of the list in which there is not any relevant item at all may be omitted. For example, if there is not any relevant item that belong to the list 21i at all, after the list 21h is displayed, display of the list 21i may be skipped, and the list 21j is displayed.

Note that, in the above-described embodiment, the display control unit 33 may be configured to perform control such that, for a list for which the determination unit 32 has determined that it is not possible to display all of items, the list is reduced in size so as to fit in the display area 18 and displayed, and then, the list is gradually enlarged such that only some of the items are displayed. Thus, when the list has been reduced in size, although displayed characters are too small and it is difficult to distinguish the items from one to another, the entire list classified for each predetermined category may be easily known without scrolling.

Also, in the above-described embodiment, the display control unit 33 may be configured to perform control such that the lists are switched from one to another in an order determined in accordance with the number of items that belong to each of the lists and are thus displayed in the display area 18. Thus, in accordance with the order of the lists in which the lists are switched from one to another and thus displayed, the number of items that belong to each of the lists may be known.

Note that, in the above-described embodiment, the display device 13 further includes a second reception unit that receives selection of an item in a list and a storage control unit that performs control such that a frequency of selection of the item selection of which has been received by the second reception unit is stored. Then, the display control unit 33 may be configured to perform control such that, in accordance with the frequency of selection of each item, which has been stored, the lists are sequentially displayed from the list including the item. Thus, a list including an item the frequency of selection of which is higher is more preferentially displayed, and therefore, the convenience of the user may be increased.

Also, although, in the above-described embodiment, the mobile terminal device control unit 12 includes the first reception unit 31 or the like, the present disclosure is not limited thereto, but a configuration in which the display device 13 itself includes a control unit and the control unit includes the first reception unit 31 or the like may be employed.

Note that, for a display method according to another embodiment, a configuration described below may be employed. That is, the display method is a display method by which it is possible to display a plurality of lists which are classified into a plurality of groups for each predetermined category and in which a plurality of items is arranged in a predetermined order. The display method includes steps of receiving a request for display of a plurality of lists, determining, when the request for display is received by the step of receiving, whether or not it is possible to display all of items in a display area of a display screen in an arrangement direction of items for each list, and performing, in sequentially displaying the plurality of lists in the display area, control such that, for a list for which it has been determined in the step of determining that it is not possible to display all of the items, all of the items in the list are displayed once, and then, only some of the items are displayed. Using the above-described display method, the convenience of the user may be increased.

Also, a recording medium according to still another embodiment may have a configuration below. That is, the recording medium is a non-transitory computer-readable recording medium in which a program that may be executed by a computer may be recorded. The program causes a computer to realize a reception function of receiving a request for display of a plurality of lists which are classified into a plurality of groups for each predetermined category and in which a plurality of items is arranged in a predetermined order, a determination function of determining, when the request for display is received, whether or not it is possible to display all of items in a display area of a display screen in an arrangement direction of items for each list, and a display control function of performing, in sequentially displaying the plurality of lists in the display area, control such that, for a list for which the determination function has determined that it is not possible to display all of the items, all of the items in the list are displayed once, and then, only some of the items are displayed.

Note that a configuration below may be employed. That is, the display device 13 is able to display the plurality of lists 21a to 21j which are classified into a plurality of groups for each predetermined category and in which a plurality of items is arranged in a predetermined order. The display device 13 includes the display screen 16, the first reception unit 31, the determination unit 32, and the display control unit 33. The display screen 16 displays information. The first reception unit 31 receives a request for display of the plurality of lists 21a to 21j. When the first reception unit 31 receives the request for display, the determination unit 32 determines whether or not it is possible to display all of items in the display area 18 of the display screen 16 in an arrangement direction of items for each of the lists 21a to 21j. In reducing the plurality of lists 21a to 21j in size or simultaneously arranging and displaying selected specific items on the display screen 16, the display control unit 33 performs control such that, for the lists 21a to 21j for which the determination unit 32 has determined that it is not possible to display all of items, the items are displayed by scrolling forward from an item arranged last in the arrangement direction.

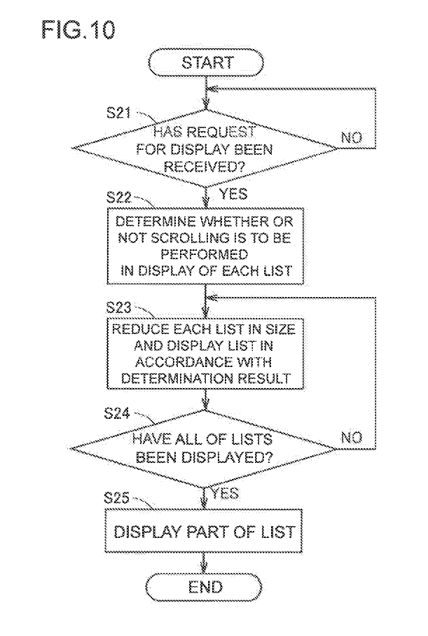

FIG. 10 is a flowchart illustrating a flow of processing when the plurality of lists 21a to 21j is reduced in size and is simultaneously arranged and displayed. With reference to FIG. 10, a flow of processing when the plurality of lists 21a to 22j is reduced in size and is simultaneously arranged and displayed will be described.

With reference to FIG. 10, the first reception unit 31 determines whether or not the first reception unit 31 has received the request for display (S21). When the first reception unit 31 receives the request for display (YES in S21), the determination unit 32 determines whether or not it is possible to display all of items in the display area 18 of the display screen 16 in the arrangement direction of the items for each of the lists 21a to 21j, that is, whether or not scrolling is to be performed in display of each of the lists 21a to 21j (S22). Specifically, the length L₂ in the arrangement direction indicated by the arrow D₁ when the items are arranged in the above-described manner is calculated for each of the lists 21a to 21j. Then, whether or not scrolling is to be performed is determined for each of the lists 21a to 21j. Then, the display control unit 33 performs control such that each of the lists 21a to 21j is reduced in size and the lists 21a to 21j are simultaneously arranged and displayed in accordance with a result of the determination (S23).

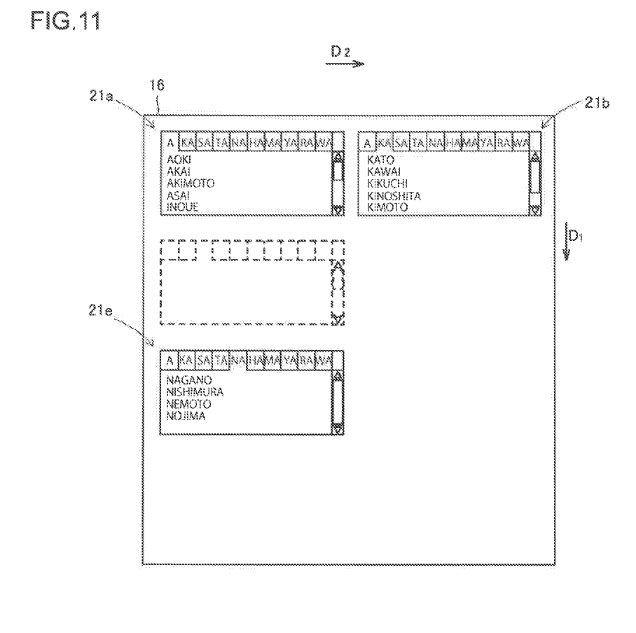

FIG. 11 is a diagram illustrating a part of an example of the display screen 16 in which each of the lists 21a to 21j is reduced in size and the lists 21a to 21j are simultaneously arranged and displayed. With reference to FIG. 11, in the display screen 16, the lists 21a, 21b, and 21e that have been reduced in size are displayed. Illustration of the other lists 21c, 21d, and 21f to 21j is omitted. In FIG. 11, the lists 21a and 21b are displayed by scrolling forward from the item arranged last in the arrangement direction in the direction opposite to the direction indicated by the arrow D₁. The list 21e is displayed as it is.

In the above-described manner, after all of the lists are displayed (YES in S24), some of the lists 21a to 21j are displayed and processing is terminated (S25).

With this configuration, the entire contents of the lists 21a to 21j classified for each predetermined category may be easily known. In this case, efficiency in terms of time may be increased, as compared to a case in which all of items are displayed once while switching from one to another among the lists 21a to 21j.

Note that, although, in this embodiment, a case in which the display control unit 33 reduces lists in size and simultaneously arranges the lists has been described, the present disclosure is not limited thereto and the display control unit 33 may be applied to a case in which selected specific items are simultaneously arranged and displayed on the display screen 16. That is, in simultaneously arranging the selected specific items and displaying the specific items on the display screen 16, the display control unit 33 performs control such that, for the lists 21a to 21j for which the determination unit 32 has determined that it is not possible to display all of items, the items are displayed by scrolling forward from the item that is arranged last in the arrangement direction.

Also, in this embodiment, for one of the lists 21a to 21j for which scrolling is finished and display of all of the items for a certain time is finished, the display area, that is, a window, thereof may be closed. That is, the display control unit 33 performs control such that the one of the list 21a to 21j for which scrolling is finished is closed and thus is non-displayed. Then, display of one of the lists 21a to 21j which being scrolled may be enlarged so as to use the closed area. Thus, visibility may be further increased. Also, the lists 21a to 21j may be reduced in size, not are non-displayed. Note that the display control unit 33 may be configured to perform control to display in the list, if there is not any relevant item that belongs to the list at all, that there is not any relevant item that belongs to the list at all.

Note that, in this embodiment, the display control unit 33 may be configured to perform, when one of the lists 21a to 21j for which scrolling is finished is closed and thus is non-displayed or is reduced in size, control such that the other items are enlarged and the enlarged items are displayed. The other items are items of one or more of the lists 21a to 21j for which scrolling is not finished yet.

Also, in this embodiment, adjustment may be performed such that all of scroll end times are matched. That is, the display control unit 33 may be configured to perform control such that the scrolling speed of each of the lists 21a to 21j is adjusted to cause scrolling of each of all of the lists 21a to 21j to be finished at the same timing and display is performed. Thus, it is possible to recognize the scrolling speed, and thus, to know a volume of the number of items in each of the lists 21a to 21j.

Note that, in this embodiment, the display control unit 33 may be configured to perform control such that specific items are selectively displayed directly under a tab.

Also, although, in the above-described embodiment, the mobile terminal device control unit 12 includes the first reception unit 31, the present disclosure is not limited thereto, a configuration in which the display device 13 itself includes a control unit and the control unit includes the first reception unit 31 or the like may be employed.

Note that, for a display method according to still another embodiment, a configuration below may be employed. That is, the display method is a display method by which it is possible to display a plurality of lists which are classified into a plurality of groups for each predetermined category and in which a plurality of items is arranged in a predetermined order. The display method includes steps of receiving a request for display of a plurality of lists, determining, when the request for display is received by the receiving, whether or not it is possible to display all of the items in a display area of a display screen in an arrangement direction of the items for each list, and performing, in reducing the plurality of lists in size or simultaneously arranging selected specific items to display the selected specific items on the display screen, control such that, for a list for which it has been determined in the determining that it is not possible to display all of the items, all of the items in the list are displayed once, and then, only some of the items are displayed. Using the above-described display method, the convenience of the user may be increased.

Also, a recording medium according to still another embodiment may have a configuration below. That is, the recording medium is a non-transitory computer-readable recording medium in which a program that may be executed by a computer may be recorded. The program causes a computer to realize a reception function of receiving a request for display of a plurality of lists which are classified into a plurality of groups for each predetermined category and in which a plurality of items is arranged in a predetermined order, a determination function of determining, when the request for display is received, whether or not it is possible to display all of the items in a display area of a display screen in an arrangement direction of items for each list, and a display control function of performing, in reducing the plurality of lists in size or simultaneously arranging selected specific items to display the selected specific items on the display screen, control such that, for a list for which the determination function has determined that it is not possible to display all of the items, all of the items in the list are displayed once, and then, only some of the items are displayed.

Note that a configuration below may be employed. That is, a display device is able to display icons of functions which are classified into a plurality of groups. The display device includes a display screen that displays information, an icon display control unit that performs control such that the icons are arranged and displayed on the display screen, a selection reception unit that receives selection of one of the icons that are displayed by the icon display control unit, and a detailed setting display control unit that performs control such that all of detailed settings of the function displayed in the icon selection of which has been received by the selection reception unit are displayed once in a direction that crosses an icon arrangement direction, and then, some of the detailed settings are non-displayed. The above-described configuration may be employed.

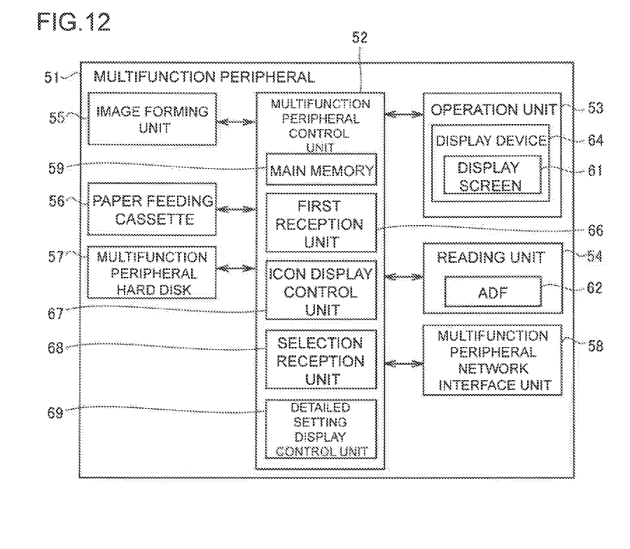

Note that the above-described display device is incorporated, for example, in an information processing device, such as a multifunction peripheral, which performs image information processing, such as image forming or the like, and is thus used. FIG. 12 is a block diagram illustrating a configuration of a multifunction peripheral when a display device according to still another embodiment is applied to the multifunction peripheral as an information processing device.

With reference to FIG. 12, a multifunction peripheral 51 includes a plurality of functions, such as a copying function, a printer function, a facsimile function, or the like, in relation to image processing. The multifunction peripheral 51 includes a multifunction peripheral control unit 52, an operation unit 53, a reading unit 54, an image forming unit 55, a paper feeding cassette 56, a multifunction peripheral hard disk 57, and a multifunction peripheral network interface unit 58 that is used for connecting to a network (not illustrated).

The multifunction peripheral control unit 52 performs control of the entire multifunction peripheral 51. Note that the multifunction peripheral control unit 52 includes a processor, a random access memory (RAM), a read processing unit (ROM), or the like. The processor is formed of a central processing unit (CPU), ASIC, MCU, or the like, and includes a main memory 59 that temporarily stores data. The operation unit 53 includes a display device 64 according to still another embodiment. The operation unit 53 includes a display screen 61 of a touch panel type as a display unit that displays information that is transmitted from a multifunction peripheral 51 side or input contents of the user. The operation unit 53 receives an input of an image forming condition, such as the number of print copies, gradation, or the like, which is related to image forming, from the user. The reading unit 54 includes an auto document feeder (ADF) 62 as a document conveyance device that conveys a document set in a set position to a reading position. The reading unit 54 reads an image of the document set on the ADF 62 or placed on a mounting table (not illustrated). As the paper feeding cassette 56, a plurality of paper feeding cassettes 56 is provided and each of the plurality of paper feeding cassettes 56 is able to store a plurality of sheets of paper therein. The image forming unit 55 forms an image on a sheet of paper that has been conveyed from the paper feeding cassettes 56, based on image data read by the image reading unit 54 or image data that has been transmitted via the network (not illustrated). The multifunction peripheral hard disk 57 stores data, such as the transmitted image data, the input image forming condition, or the like, which is related to image forming.

A configuration of the multifunction peripheral control unit 52 will be described below. The multifunction peripheral control unit 52 includes a first reception unit 66, an icon display control unit 67, a selection reception unit 68, and a detailed setting display control unit 69. The first reception unit 66 receives a request for display of icons. When the first reception unit 66 receives the request for display of icons, the icon display control unit 67 performs control such that the icons are arranged and displayed on the display screen 61. The selection reception unit 68 receives selection of one of the icons that have been controlled to be displayed by the icon display control unit 67. The detailed setting display control unit 69 performs control such that all of detailed settings of the function displayed in the icon selection of which has been received by the selection reception unit 68 are displayed once in a direction that crosses an icon arrangement direction, and then, some of the detailed settings are non-displayed. In this case, the detailed setting display control unit 69 performs control such that the detailed settings of the function are displayed in a direction that is perpendicular to the icon arrangement direction. The above-described configurations will be described in detail later.

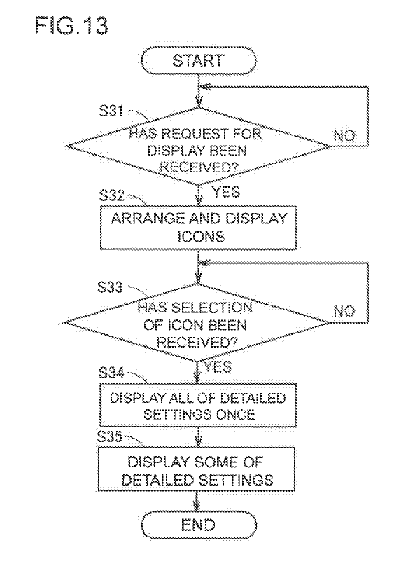

Next, a case in which icons of functions which are classified into a plurality of groups are displayed using the above-described multifunction peripheral 51 will described. FIG. 13 is a flowchart illustrating a flow of processing when icons of functions which are classified into a plurality of groups are displayed. With reference to FIG. 12 and FIG. 13, first, the first reception unit 66 receives a request for display of icons (S31). Specifically, for example, an operation, such as detection of a tap of the display screen 61 or the like, of for recovery from a so-called sleep mode, is received.

When the first reception unit 66 receives the request for display of icons (YES in S31), the icon display control unit 67 displays the icons (S32). In this case, a plurality of icons is arranged and displayed on the display screen 61.

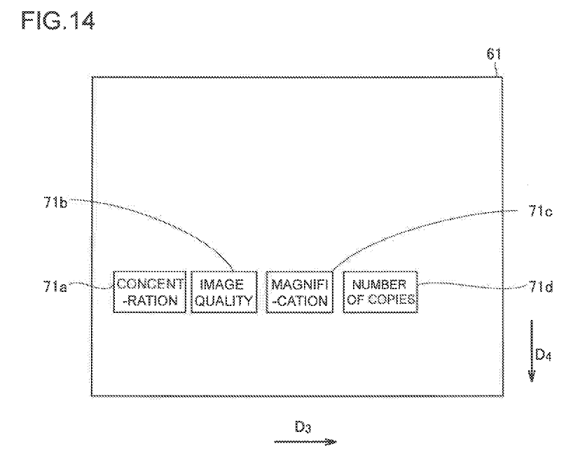

FIG. 14 is a diagram illustrating an example of the display screen 61 in which a plurality of icons is arranged and displayed. With reference to FIG. 14, on the display screen 61, four icons 71a, 72b, 71c, and 71d are arranged and displayed in a lateral direction indicated by an arrow D₃ in FIG. 14. Each of the icons 71a to 71d is an icon that is used when setting related to image forming of the multifunction peripheral 51 is performed. Specifically, in the icon 71a, “CONCENTRATION” is indicated and detailed setting of concentration in image forming may be performed by detecting a tap of the icon 71a. In the icon 71b, “IMAGE QUALITY” is indicated and detailed setting of image quality in image forming may be performed by detecting a tap of the icon 71b. In the icon 71c, “MAGNIFICATION” is indicated and detailed setting of magnification in image forming may be performed by detecting a tap of the icon 71c. In the icon 71d, “NUMBER OF COPIES” is indicated and detailed setting of the number of copies in image forming may be performed by detecting a tap of the icon 71d. The icons 71a to 71d are configured to be movable in a left-and-right direction, that is, the direction indicated by the arrow D₃ in FIG. 14 or in an opposite direction thereto. That is, one of the icons 71a to 71d may be caused to be located at the center of the display screen 61 by sliding the icons 71a to 71d.

After the icons 71a to 71d are displayed on the display screen 61 as illustrated in FIG. 14, the selection reception unit 68 receives selection of one of the icons 71a to 71d. This selection is performed when detailed setting is performed. In this case, it is assumed that the icon 71c that is used for performing detailed setting for “MAGNIFICATION” has been selected. This selection is made by sliding the icon 71c to cause the icon 71c to be located at the center of the display screen 61.

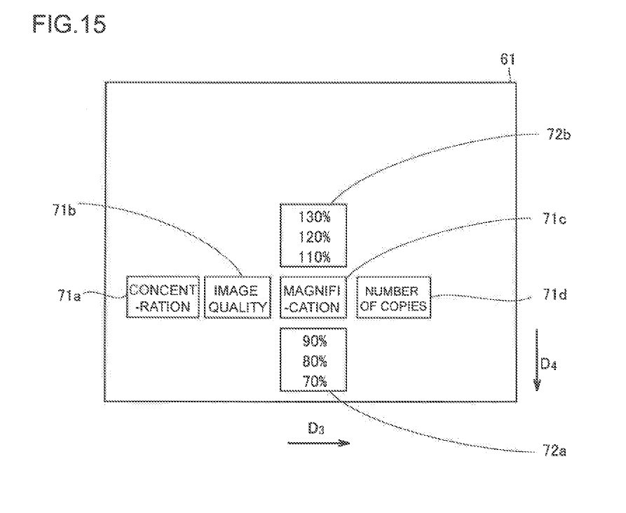

FIG. 15 is a diagram illustrating an example of the display screen 61 that is displayed when selection of the icon 71c is received. With reference to FIG. 15, when the icon 71c is selected (YES in S33), the detailed setting display control unit 69 displays all of detailed settings of the function displayed in the icon 71c once in a direction that crosses an arrangement direction of the icon 71c (S34). In this case, the detailed setting display control unit 69 performs control such that the detailed settings of the function are displayed in a direction that is perpendicular to the arrangement direction of the icon 71c, that is, specifically, a direction indicated by an arrow D₄ or an opposite direction thereto.

Also, the detailed setting display control unit 69 performs control such the detained settings of the function are displayed by scrolling from the center. Specifically, the magnification at which reduction in size is performed is displayed by every 10%, that is, “90%”, “80%”, and “70%” are displayed, by scrolling downward from an area 72a under the icon 71c. Also, the magnification at which enlargement is performed is displayed by every 10%, that is, “110%”, “120%”, and “130%” are displayed, by scrolling upward from an area 72b above the icon 71c. In this case, the bar 26 illustrated in FIG. 3 or the like, which has been described above, may be displayed therewith.

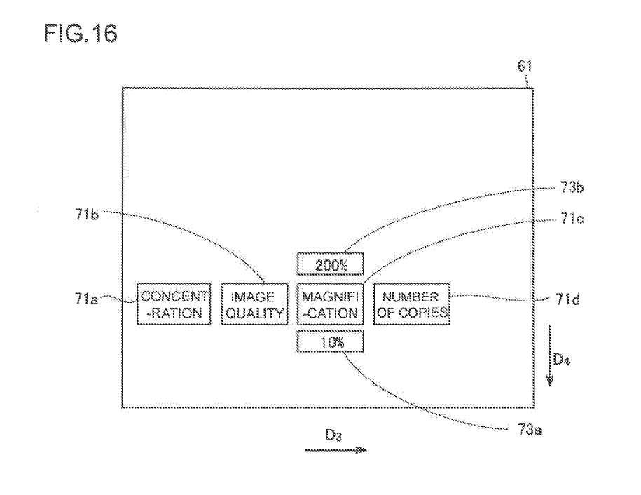

The detailed setting display control unit 69 displays all of detailed settings once, and then, non-displays some of the detailed settings. In this case, the detailed setting display control unit 69 displays some of the detailed settings, that is, specifically, a detailed setting of a function which is farthest from the center (S35). FIG. 16 is a diagram illustrating an example of the display screen 61 when a detailed setting of a function which is farthest from the center is displayed. With reference to FIG. 16, in the display screen 61, the four icons 71a to 71d, a detailed setting of the function which is arranged in an area 73b above the icon 71c and in which “200%” is indicated, and a detailed setting of the function which is arranged in an area 73a under the icon 71c and in which “10%” is indicated are displayed. The user is able to know by looking at the display of the areas 73a and 73b that, for the detailed setting for “MAGNIFICATION” which is set by tapping the icon 71c, an upper limit is “200%” and a lower limit is “10%”.

With this configuration, when the icons 71a to 71d of functions which are classified into a plurality of groups are displayed on the display screen 61, control is performed such that all of the detailed settings of the function that is displayed in the icon 71c are displayed once in a direction that crosses the arrangement direction of the icon 71c, and then, some of the detailed settings are non-displayed. Thus, when all of the detailed settings of the function are displayed, the user is able to know all of the detailed settings of the function. Also, because all of the detailed settings of the function are displayed once, and then, some of the detailed settings are non-displayed, difficulty in viewing the display of the display screen 61 which is caused by displaying the detailed settings of the function may be reduced. Therefore, the convenience of the user may be increased.

In this case, the detailed settings of the function are displayed in the direction perpendicular to the arrangement direction of the icon 71c, and therefore, visual recognition of the other icons 71a, 71b, and 71d is not disturbed.

Also, in this case, the detailed settings of the function which are farthest from the center are displayed, and therefore, so-called critical detailed settings of the function may be easily known.

Note that, in the above-described embodiment, the detailed setting display control unit 69 may be configured to perform control such that all of detailed settings of a function are displayed once, and then, all of the detailed settings are non-displayed. Thus, the visibility of the display of the display screen 61 may be increased.

Also, in the above-described embodiment, the detailed setting display control unit 69 may be configured to perform control such that, if there is no detailed setting of a function at all, it is displayed on the display screen 61 that there is no detailed setting of a function at all. Specifically, for example, if, when the icon 71c is tapped, an image cannot be enlarged, a display of “IMAGE CANNOT BE ENLARGED.” may be displayed above the icon 71c for a certain time. Thus, the user is able to easily know that there is no detailed setting of a function.

Note that, although, in the above-described embodiment, a detailed setting of a function which is farthest from the center is displayed by scrolling, the present disclosure is not limited thereto, and a configuration in which, after the detailed setting of the function which is farthest from the center is displayed for a certain time, a detailed setting of the function which is closest to the center is displayed may be employed.

Also, although, in the above-described embodiment, reception of selection by the selection reception unit 68 is performed by sliding the icons 71a to 71d to the center of the display screen 61, the present disclosure is not limited thereto and, for example, reception of selection may be performed by detection of a tap of the icons 71a to 71d or detection of a long press of the icons 71a to 71d.

Note that, in the above-described embodiment, based on a predetermined gesture, display of the icons 71a to 71d may be moved in an oblique direction, or display of the areas 72a, 72b, 73a, and 73b may be displayed so as to be inclined relative to a direction in which the icons 71a to 71d move.

Also, although, in the above-described embodiment, the multifunction peripheral control unit 52 includes the first reception unit 66, the present disclosure is not limited thereto, and a configuration in which the display device 64 itself includes a control unit and the control unit includes the first reception unit 66 or the like may be employed.

Note that a display method according to another embodiment may have a configuration below. That is, the display method is a display method by which it is possible to display icons of functions which are classified into a plurality of groups. The display method includes steps of receiving a request for display of icons, performing, when the request for display of icons is received by the receiving, control such that the icons are arranged and displayed on a display screen, receiving, after the performing control, selection of one of the icons that are displayed, and performing, after the receiving selection, control such that all of detailed settings of the function displayed in the icon selection of which has been received are displayed once in a direction that crosses an icon arrangement direction, and then, some of the detailed settings are non-displayed. With the above-described display method, the convenience of the user may be increased.

Also, a recording medium according to still another embodiment may have a configuration below. That is, the recording medium is a non-transitory computer-readable recording medium in which a program that may be executed by a computer may be recorded. The program causes a computer to realize a reception function of receiving a request for display of icons, a function of performing, when the request for display of icons is received by the reception function, control such that the icons are arranged and displayed on a display screen, a selection reception function of receiving selection of one of the icons that have been controlled to be arranged and displayed by the function of performing control, and a detailed setting display control function of performing control such that all of detailed settings of the function displayed in the icon selection of which has been received by the selection reception function once in a direction that crosses an icon arrangement direction, and then, some of the detailed settings are non-displayed.

Note that, although, according to the above-described embodiments, a display device is applied to a mobile terminal device or an information processing device, the present disclosure is not limited thereto and the display device may be applied to another information processing device, that is, for example, a personal computer, a smartphone, or the like. As a matter of course, the display method described above or the like may be applied to such an information processing device.

The embodiments and examples disclosed herein are provided merely for illustrative purpose in every respect and are not intended to be limiting in any aspect. The scope of the present disclosure is defined by the scope of claims rather than the above-described description, and is intended to include any modifications within the scope and meaning equivalent to the terms of the claims.

A display device and a display method according to the present disclosure are effectively used particularly when convenience of a user is desired to be increased.

What is claimed is:

1. A display device which is able to display a plurality of lists which are classified into a plurality of groups for each predetermined category and in which a plurality of items is arranged in a predetermined order, the display device comprising:
a display screen that displays information;
a first reception unit that receives a request for display of the plurality of lists;
a determination unit that determines, when the first reception unit receives the request for display, whether or not it is possible to display all of items in a display area of the display screen in an arrangement direction of the items for each of the lists; and
a display control unit that performs, in sequentially displaying the plurality of lists in the display area, control such that, for the list for which the determination unit has determined that it is not possible to display all of the items, all of the items in the list are displayed once, and then, only some of the items are displayed.

2. The display device according to claim 1,
wherein the display control unit performs control such that, for the list for which the determination unit has determined that it is not possible to display all of the items, the items are displayed by scrolling forward from the item arranged last in the arrangement direction.

3. The display device according to claim 1,
wherein the display control unit performs control such that, for the list for which the determination unit has determined that it is not possible to display all of the items, the list is reduced in size so as to fit in the display area and thus is displayed, and then, the size-reduced list is gradually enlarged such that only some of the items are displayed.

4. The display device according to claim 1,
wherein the display control unit performs control such that, for the list for which the determination unit has determined that it is not possible to display all of the items, all of the items in the list are displayed for a predetermined time.

5. The display device according to claim 1,
wherein the display control unit performs control such that, if there is not any relevant item that belongs to the list at all, it is displayed in the list that there is not any relevant item that belongs to the list at all.

6. The display device according to claim 1,
wherein the display control unit performs control such that the lists are switched from one to another in an order determined in accordance with the number of the items that belong to each of the lists and are displayed in the display area.

7. The display device according to claim 1, further comprising:
a second reception unit that receives selection from the items in the lists; and
a storage control unit that performs control such that a frequency of selection of the item selection of which has been received by the second reception unit is stored,
wherein the display control unit performs control such that, in accordance with the frequency of selection of the item, which has been stored, the lists are sequentially displayed from the list including the item.

8. The display device according to claim 1,
wherein the display control unit performs control such that the lists are displayed in a tab format.

9. A display method by which it is possible to display a plurality of lists which are classified into a plurality of groups for each predetermined category and in which a plurality of items is arranged in a predetermined order, the display method comprising steps of:
receiving a request for display of the plurality of lists;
determining, when the request for display is received by the receiving, whether or not it is possible to display all of items in a display area of the display screen in an arrangement direction of the items for each of the lists; and
performing, in sequentially displaying the plurality of lists in the display area, control such that, for the list for which it has been determined by the determining that it is not possible to display all of the items, all of the items in the list are displayed once, and then, only some of the items are displayed.

10. A display device which is able to display icons which are classified into a plurality of groups, the display device comprising:
a display screen that displays information;
a first reception unit that receives a request for display of the icons;
an icon display control unit that performs, when the first reception unit receives the request for display of the icons, control such that the icons are arranged and displayed on the display screen;
a selection reception unit that receives selection of one of the icons that have been controlled to be arranged and displayed by the icon display control unit; and a detailed setting display control unit of performing control such that all of detailed settings of a function displayed in the icon selection of which has been received by the selectin reception unit are displayed once in a direction that crosses an icon arrangement direction, and then, some of the detailed settings are non-displayed.

11. The display device according to claim 10,
wherein the detailed setting display control unit performs control such that the detailed settings of the function are displayed in a direction that is perpendicular to the icon arrangement direction.

12. The display device according to claim 10,
wherein the detailed setting display control unit performs control such that the detailed settings of the function are displayed by scrolling from a center.

13. The display device according to claim 10,
wherein the detailed setting display control unit performs control such that all of the detailed settings of the function are displayed once, and then, the detailed setting of the function, which is farthest from the center, is displayed.

14. The display device according to claim 10,
wherein the detailed setting display control unit performs control such that all of the detailed settings of the function are displayed once, and then, all of the detailed settings of the function are non-displayed.

15. The display device according to claim 10,
wherein the detailed setting display control unit performs control such that, if there is not the detailed setting of the function at all, it is displayed on the display screen that there is not the detailed setting of the function at all.
